(19) United States
(12) Patent Application Publication
(10) Pub. No.: US 2017/0004522 A1
(43) Pub. Date: Jan. 5, 2017

(54) COUPON ISSUING METHOD AND COUPON ISSUING SYSTEM

(71) Applicant: Kwang Ho LEE, Busan (KR)

(72) Inventor: Kwang Ho LEE, Busan (KR)

(21) Appl. No.: 14/777,592

(22) PCT Filed: Mar. 19, 2014
(86) PCT No.: PCT/KR2014/002316

§ 371 Date: Sep. 16, 2015

(30) Foreign Application Priority Data
Mar. 19, 2013 (KR) 10-2013-0029230
Mar. 19, 2014 (KR) 10-2014-0032107

(51) Int. Cl. G06Q 30/02

(52) U.S. Cl. CPC G06Q 30/0207; G06Q 30/0201

(57) ABSTRACT

Provided is a coupon issuing method and to a coupon issuing system which concerns a coupon issuing method implemented by means of a coupon issuing system capable of interaction with a user, the method comprising the steps of: acquiring image data and store identification data generated by the user, generating a coupon on the basis of the image data and store identification data; and issuing the generated coupon.

### BACKGROUND

The present invention relates to a coupon issuing method and a coupon issuing system, and in particular to a method and system for generating and issuing a coupon on the basis of an image generated by a user.

In recent years, various kinds of coupons are being used at a restaurant, a movie theater, an online shopping mall, etc., which allow a customer to buy products and services at lower prices. A coffee shop, a book store, a restaurant, a beauty shop, a beauty parlor, a private educational institute, a travel/accommodation facility, a recreation/movie theater, etc. which provides various kinds of product and services may promote the sales of such products and services, thus increasing sales.

Since the above-mentioned coupons may be distributed only through a distribution enterprise established for the distribution of such coupons, the above-listed shops cannot have any chances to provide the coupons to a number of unspecified customers.

To this end, the Korean patent application number 2010-0096344 describes a method for providing a discount coupon sale agent service using a social commerce, wherein for a sale agent of a discount coupon with respect to an item or a sale service requested from an advertiser, a social commerce server provides a discount coupon on an internet webpage. As a condition for finally determining the purchase of the discount coupon, a minimum sale quantity and sale period are given together. A user pays a purchase money corresponding to the price discounted with a discount coupon and inputs a recommender of the discount coupon. The social commerce server provides a reward for the recommendation provided by a multi-level marketing method with respect to the recommender and an upper level recommender. The system is designed to increase the reward on the basis of a number of recommendations calculated in the multi-level marketing method with respect to each recommender. In addition, a predetermined upper limit is set with respect to the above reward. The above-described prior art document discloses just a coupon sale method, not resolving the problem wherein the coupons should be distributed through only a limited distribution enterprise. To this end, it needs to develop a technology which is able to resolve the above mentioned problem.

In recent years, a SNS (Social Network Service) becomes a hot issue. The users can post an image, a video, etc. taken by himself on a SNS page. In particular, if a specific product or service is purchased or used, the user posts an image or video showing the product or service that the user purchased or used before. There may be a potential way to resolve the above-mentioned problems using the above new trend.

The inventor of the present invention owns the above-described background technology for the development of the present invention or as a technical information obtained during the development of the present invention, so such a background technology may not mean a prior art technology open to the public.

### SUMMARY OF THE INVENTION

Accordingly, It is an object of the present invention to provide a coupon issuing method and a coupon issuing system.

To achieve the above object, according a first aspect of the present invention, there is provided a coupon issuing method which may be executed by a coupon issuing system wherein an interaction with a first user is available, which may include, but is not limited to, obtaining an image information and shop identification information generated by the first user; generating a coupon on the basis of the image information and shop identification information; and issuing the generated coupon.

To achieve the above object, according a second aspect of the present invention, there is provided a coupon issuing system wherein an interaction with a first user is available, which may include, but is not limited to, an information obtaining unit configured to obtain an image information and shop identification information generated by the first user; a coupon generating unit configured to generate a coupon on the basis of the image information and shop identification information; and a coupon issuing unit for issuing the generated coupon.

On the basis of any one of the above-mentioned objects of the present invention, an exemplary embodiment of the present invention can provide a coupon issuing method and to coupon issuing system.

On the basis of any one of the above-mentioned objects of the present invention, the present invention can provide a coupon issuing method and to coupon issuing system which allow to introduce a self-advertisement of a user at a coffee shop, a restaurant, a movie theater, etc., thus naturally advertising shops.

According to any one of the objects of the present invention, a user can share an advertisement containing a shop benefit with his colleagues on the SNS service, which may promote the sale in the shop, while providing the colleagues with a reliable advertisement.

The effects which may obtained in the present invention are not limited to the above-described effects. Other effects not mentioned in the above may be understood clear by a person having ordinary skill in the art with the aid of the descriptions below.

### BRIEF DESCRIPTION OF DRAWINGS

FIG. 1 is a view illustrating a configuration of a coupon issuing system according to an exemplary embodiment of the present invention.

FIG. 2 is a block diagram illustrating a coupon issuing system according to an exemplary embodiment of the present invention.

FIG. 3 is a flow chart for describing a coupon issuing method according to an exemplary embodiment of the present invention.

FIGS. 4 to 7 are views for describing a coupon issuing method according to an exemplary embodiment of the present invention.

### DETAILED DESCRIPTION OF THE INVENTION

The preferred exemplary embodiments of the present invention will be described with reference to the accompanying drawings so that a person having ordinary skill in the art can implement the present invention. The present invention may be implement in various forms, which is not limited thereto. For the sake of better understanding, the portions not directly related to the description of the present invention will be omitted, and similar components throughout the specification are given same reference numbers.

In the descriptions of the present invention, the term “connected” with other portions means a “direct connection” and a “electrical connection” with a predetermined component being connected between the two connected components. The term “include”, unless otherwise stated, may mean “including another component”, not excluding other components.

The present invention will be described with reference to the accompanying drawings.

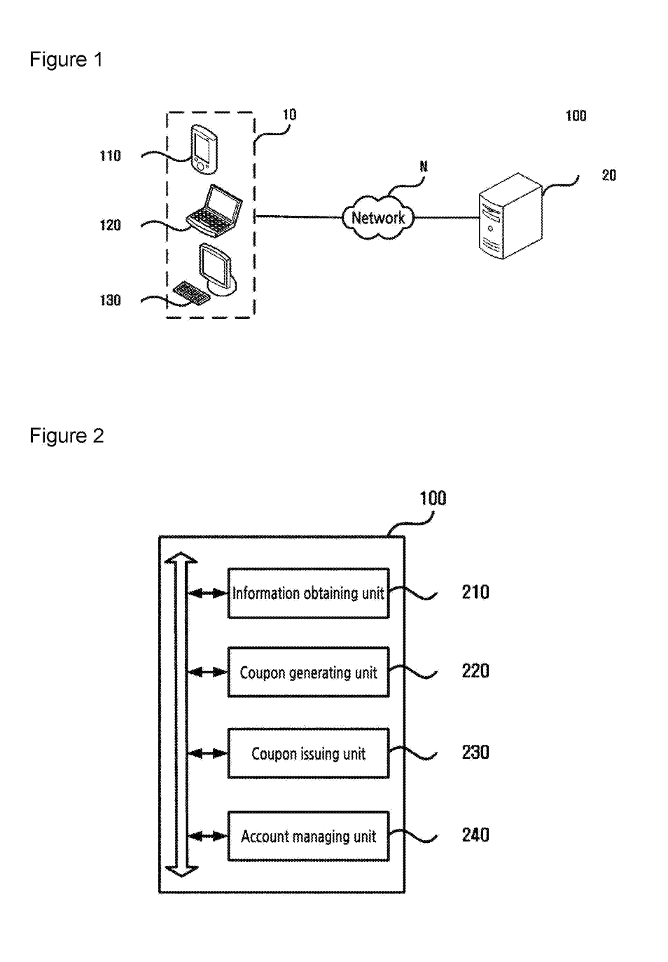

FIG. 1 is a view illustrating a configuration for describing a coupon issuing system 100 according to an exemplary embodiment of the present invention.

The coupon issuing system 100 is a system which is able to interact with a user and may include, but is not limited to, a user terminal 10, and a coupon issuing server 20.

The user terminal 10 and the coupon issuing server 20 may communicate each other through a network “N”. The network “N” may be any of all kinds of wired/wireless networks, for example, a local area network (LAN), a wide area network (WAN), a value added network (VAN), a personal area network (PAN), a mobile communication network, a Wibro (Wireless broadband internet), a mobile WiMAX, a HSDPA (High Sped Downlink Packet Access), and a satellite communication network.

For this, the user terminal 10 is configured to process an interaction with a user who wants to generate a coupon through a coupon issuing system or wants to receive a coupon.

For example, the user terminal 10 may have a client program to execute a coupon issuing method. The coupon issuing service provided by the coupon issuing system can be provided to a user who may control the user terminal 10.

At this time, depending on the roles of the user, the user terminal 10 may be classified into a first terminal 110, a second terminal 120 and a third terminal 130.

The first terminal 110 may obtain an image information and a shop identification information to generate a coupon and may be controlled by a first user who wants to generate a coupon.

The second terminal 120 may receive the generated coupon and may be controlled by a second user who wants to take any benefit coming together with the coupon after the coupon is obtained.

The third terminal 130 may obtain an information to generate a shop identification information and may be preferably controlled by a third user who provides an item (including product or service) which is sold on a shop like an owner or a staff of a shop. Here, the shop means all kinds of shops, for example, an online shop, an offline shop, etc.

Meanwhile, an acquaintance relationship may be set between the first user and the second user in the coupon issuing system 100 (or third party server (not shown)). If the coupon that a user, one party, has generated or obtained can be received by another user, the other party, both the users may be called “acquaintance”. The second user who has an acquaintance relationship with the first user can receive the coupon generated by the first user.

According to an exemplary embodiment of the present invention, the first terminal 110, the second terminal 120 and the third terminal 130 may perform the above-described work, but the roles of each terminal may be changed with one another. The roles of the first terminal 110, the second terminal 120 and the third terminal 130 may be changed, thus performing all the above work.

The user terminal 10 may include a photographing device (for example, a camera) to photograph an image (a still image, a motion image (video), etc.) or an identification information (one to three dimensional codes, etc.), which can be photographed. In addition, the user terminal 10 may include a reading device (RFID reader, NFC reader, etc.) which is able to read various kinds of information (for example, RFID (Radio Frequency Identification) tag, NFC (Near Field Communication) tag, etc.) which could be the target of the reading.

The user terminal 10 may be a computer, a portable terminal or a television which may access through a network “N” to a distant coupon issuing server 20 or a third party server or may be connected with other user terminals and a server. Here, the computer may be a notebook computer, a desktop computer, a laptop computer, etc. which equips with a WEB browser, and the portable terminal is a wireless communication device which has a portability and mobility and may be all kinds of handheld-based wireless communication devices, for example, PCS (Personal Communication System), PDC (Personal Digital Cellular), PHS (Personal Handyphone System), PDA (Personal Digital Assistant), GSM (Global System for Mobile Communication), IMT (International Mobile Telecommunication)-2000, CDMA (Code Division Multiple Access)-2000, W-CDMA (W-Code Division Multiple Access), Wibro (Wireless Broadband Internet), a smart phone, a mobile WiMAX (Mobile Worldwide Inter operability for Microwave Access), a wearable device, etc. The television may be IPTV (Internet Protocol Television), an internet TV, a ground wave radio TV, a cable TV, etc.

The coupon issuing server 20 may generate or issue a coupon based on a coupon issuing method while communicating with the user terminal 10.

For example, the coupon issuing server 20 may operate like a server with respect to the user terminal 10 having a client program.

The coupon issuing server 20 may receive from the user terminal 10 an image information, a shop identification information, etc. to generate coupons and may generate coupons and provide to the coupons to the user terminal 10.

Meanwhile, the coupon issuing system 100 may communicate with a third party server (not illustrated) through a network “N”.

The third party server may post the coupon received from the coupon issuing system 100 and may post the generated coupon on the user account of the third party server of the first user. The third party server may provide a SNS (Social Network Service), whereupon the second user who has an acquaintance relationship with the first user who has posted the coupon on the user account of the third party server may receive the coupon through the account of the first user.

Meanwhile, the coupon issuing server 20 and the third party server (not illustrated) may be implemented with a conventional web server to which a web access is available or a conventional mobile web server to which a mobile web access is available. The coupon issuing server 20 and the third party server (not illustrated) may be a web server which is able to provide a web service to the user terminal 10. For example, they may be a portal site server or a server system of each various wed contents providers, for example, an online shopping server, etc. The coupon issuing server 20 and the third party server (not illustrated) may be implemented with a group of server systems, for example, a load balancing server, a database server, etc.

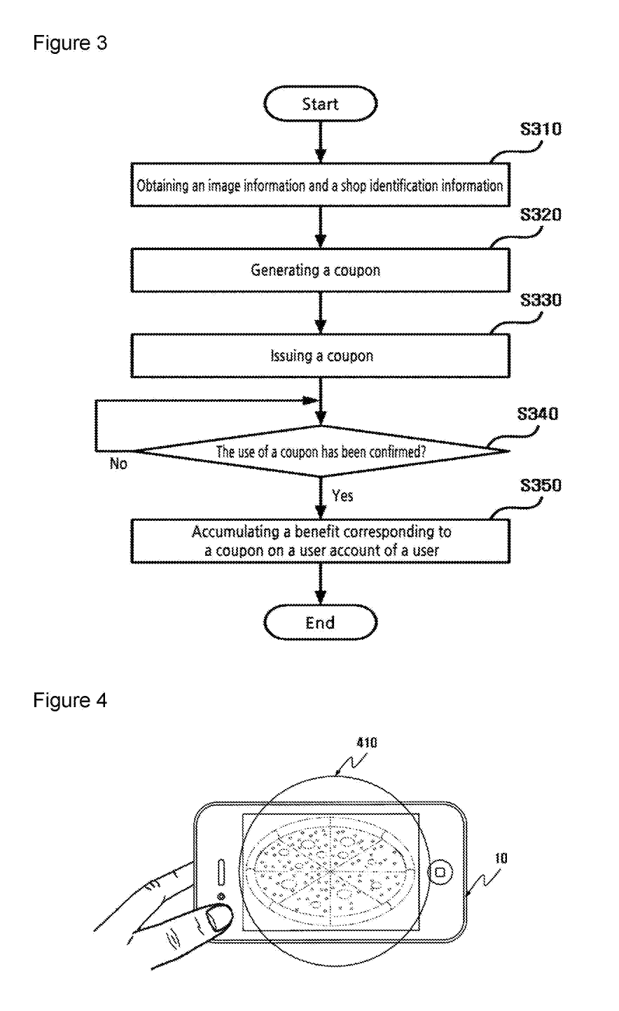

FIG. 2 is a block diagram illustrating a coupon issuing system 100 according to an exemplary embodiment of the present invention.

Referring to FIG. 2, the coupon issuing system 100 may include, but is not limited to, an information obtaining unit 210, a coupon generating unit 220, a coupon issuing unit 230 and an account managing unit 240.

The coupon issuing system 100 may include a communication unit (not illustrated) which allows a communication with internal components, for example, the information obtaining unit 210, the coupon generating unit 220, the coupon issuing unit 230 and the account managing unit 240 and also allows a communication with external components.

The coupon issuing system 100 may include a storing unit (not illustrated) to store data for executing the coupon issuing method according to an exemplary embodiment of the present invention and may communicate with an externally located storage (not illustrated), for example, a database.

The information obtaining unit 210 may obtain information to generate coupons.

The information obtaining unit 21 may obtain an image information and a shop identification information.

Here, the image information may include general information on the image generated by the user. For example, the image information may be any of an image, an image identification information, an image detail description, an image generation time and a position information on the position where the image is generated.

The shop identification information means an information to identify the shop from other shops or users. The shop identification information may be formed of a series of characters or numbers or may be implemented with a one-dimensional barcode, a two-dimensional barcode or a three-dimensional barcode or may be implemented with a RFID tag or a NFC tag. Such a shop identification information may be same as the user identification information of the third user and may be included in the user identification information of the third user or may include a user identification information of the third user.

The information obtaining unit 210 may obtain a shop identification information and may provide a photographing interface to generate an image information on the basis of the obtaining of the shop identification information and may obtain an image information through the photographing interface.

The information obtaining unit 210 may obtain an image information and may provide an input interface to receive the shop identification information and may obtain a shop identification information through the input interface.

The coupon generating unit 220 may generate a coupon based on the image information and the shop identification information.

The coupon generating unit 220 may obtain a shop information corresponding to the shop identification information and including any of a shop name information, a shop position information and a shop contact information, thus generating a coupon by adding the shop information to a coupon information.

At this time, if the matching shop information is stored in the shop identification information, the shop information may be obtained by searching for a shop information matching with the obtained shop identification information. For example, the shop information may be registered in the coupon issuing system 100 by other users or a shop owner. To this end, the coupon generating unit 220 may obtain the registered shop information by searching force the shop identification information matching with the shop information.

The coupon generating unit 220 may obtain a shop information in such a way to extract a shop information contained in the shop identification information. For example, if a shop information is contained in the obtained shop identification information itself, namely, if the shop identification information is an image, the coupon generating unit 220 may extract and obtain a shop information from the shop identification information itself based on a technique, for example, an OCR (Optical Character Reader).

The coupon generating unit 220 may generate a coupon by adding any of the user identification information of the first user who provides an image and the shop information to a coupon information. Here, the coupon information means various information that the user can confirm for reading the coupon information or a general information which is necessary for the user to use. Here, the coupon information may include any of a benefit information which can be received when using the coupon, a shop information to use coupons, an image information of the image used for the coupon, a user identification information of a user who generates a coupon, and a coupon identification information to identify the coupon.

In addition, the coupon generating unit 220 may generate a user identification information of the user which will be added to a coupon information and may add to the coupon. In addition, it may generate an identification information by combining the user identification information and the shop information (or shop identification information) and may add to a coupon. For example, the coupon generating unit 220 may generate a new identification information by combining the user identification information of the first user and the shop identification information (or the user identification information of a third user) and may add the generated identification information to the coupon information. The thusly added identification information allows an access to the account of the first user who has generated the coupon when confirming the coupon and an access to the account of the third user who will use the coupon.

The coupon generating unit 220 determines the matching of the image information and the shop identification information based on the position information included in the image information obtained for the generation of the coupon, thus generating a coupon in case of matching.

The coupon issuing unit 230 may issue the generated coupon to other users.

At this time, the coupon issuing unit 230 may issue the coupon for a predetermined time period and may continuously issue the coupon. The coupon issuing unit 230 is basically configured to issue coupons, but may issue by limiting a range (for example, a use who has generated the coupon and an acquaintance user) of targets who may receive the coupon, and the number of the targets may be limited when issuing. The coupon issuing unit 230 may provide the coupons to the second user by selecting the coupons based on the characteristic of the second user who reads the coupons (for example, the position of the second user (the position registered by the second user or the position of the second user when reading the coupon), the age of the second user, the category of the read coupon, etc.).

The coupon issuing unit 230 may issue through a service which is provided through the third party serer in such a way to transfer the coupon (or coupon information) to the third party server. Such a third party server has an allocated third party identification information to identify the third party server, so the coupon issuing unit 230 may add the third party identification information to the coupon information when transferring the coupon to the third party server.

The coupon issuing unit 230 may provide a reading interface which allows the second user who wants to receive a coupon to receive the coupon. The reading interface may allow the coupon to be downloaded by the user terminal of the second user or may allow the coupon to be downloaded on the user account of the second user or may allow the coupon to be transferred to on the user account of the third party server of the second user or may allow the coupon to be transferred to a printing device, for example, a printer.

The account managing unit 240 may allow any benefit corresponding to the coupon to be accumulated on the user account of the first user who has generated the coupon. Namely, the account managing unit 240 may allow a predetermined benefit to be accumulated, as a benefit for the generation of the image or coupon, on the user account of the first user who has generated the image or the coupon. Whenever the benefits are accumulated, the account managing unit 240 may notify to the first user in a form of a message or an e-mail or a push message the benefits have been accumulated.

Here, the benefit may be an existing goods or a virtual money. The benefit amount may be a price corresponding to a predetermined ratio of the goods sale amount corresponding to the coupon. For example, part of the amount accumulated on the user account of the third user may be accumulated, as a benefit, on the user account of the third user, and the amount of the user account of the third user may be deducted by as much as the accumulated amount. Therefore, when the benefit is accumulated, part of the coupon information may be stored in the user account.

The account managing unit 240 may confirms the use of the coupon. When the use of the coupon is confirmed (namely, if it is confirmed that the second user uses the coupon at the shop corresponding to the coupon), the benefit corresponding to the coupon may be accumulated on the user account of the first user.

The account managing unit 240 may accumulate the benefit corresponding to the coupon on the user account of the first user if it obtains a user identification information of the second user who wants to the coupon together with the coupon use confirmation request.

The account managing unit 240 may accumulate the benefit corresponding to the coupon on the user account of the first user only if the confirmation time of the coupon is within a predetermined range after the generation time of the coupon.

In order to perform the accumulation of the benefit in the above way, the account managing unit 240 may manage the user accounts of each of the first user, the second user and the third user.

The account managing unit 240 may manage the user account of the first user. For example, the account managing unit 240 may store an information on the total amount on the benefit that the first user has accumulated and may store any history (for example, the statistical history on the accumulation of the coupon information which was a ground of the accumulation of the benefit or the shop identification information corresponding to the coupon which was a ground of the accumulation of the benefit or a third party server identification information with which the coupon being a ground of the accumulation of the benefit has been provided. In addition, the account managing unit 240 may allow the first user to freely use the benefit accumulated on the user account of the first user at the shop registered in the coupon issuing system 100. At this time, the shop registered in the coupon issuing system 100 means a shop which may be recognized as an exchange value that the benefit accumulated on the user account of the coupon issuing system 100 is sold at the shop.

The account managing unit 240 may manage the user account of the second user. The account managing unit 240, therefore, may confirm if the second user who requests the coupon confirmation is a user (namely, the user who has a history on the previous use of the same coupon) who has a history on the coupon confirmation request on the same coupon. If the second user received before the discount benefit using the same coupon, the benefit is not accumulated on the user account of the first user or any benefit is not provided to the second user.

In addition, the account managing unit 240 may manage the user account of the third user. For example, it may store the shop information, the shop identification information, etc, which match with the third user or may store a coupon use history (for example, a coupon use frequency, an information on the users who have generated the coupons matching with the shops, etc.) or may generate and store a statistical data based on the above history so that the third user can read.

The account managing unit 240 may manage any information on the acquaintance relationship between the users registered in the coupon issuing system 100.

The account managing unit 24 may allow the sharing of the coupon between the users who have acquaintance relationship and may provide an evaluation interface to evaluate the first users who have generated the coupons, whereupon the second user who has downloaded the coupon generated by the first user can evaluate the first user, so other users can confirm that the coupons generated by the first user are reliable coupons.

Each component of the above coupon issuing system 100 may be implemented on any device of the user terminal 10 or the coupon issuing server 20. Each of the coupon generating unit 220, the coupon issuing unit 230 and the account managing unit 240 may be implemented on the coupon issuing server 20.

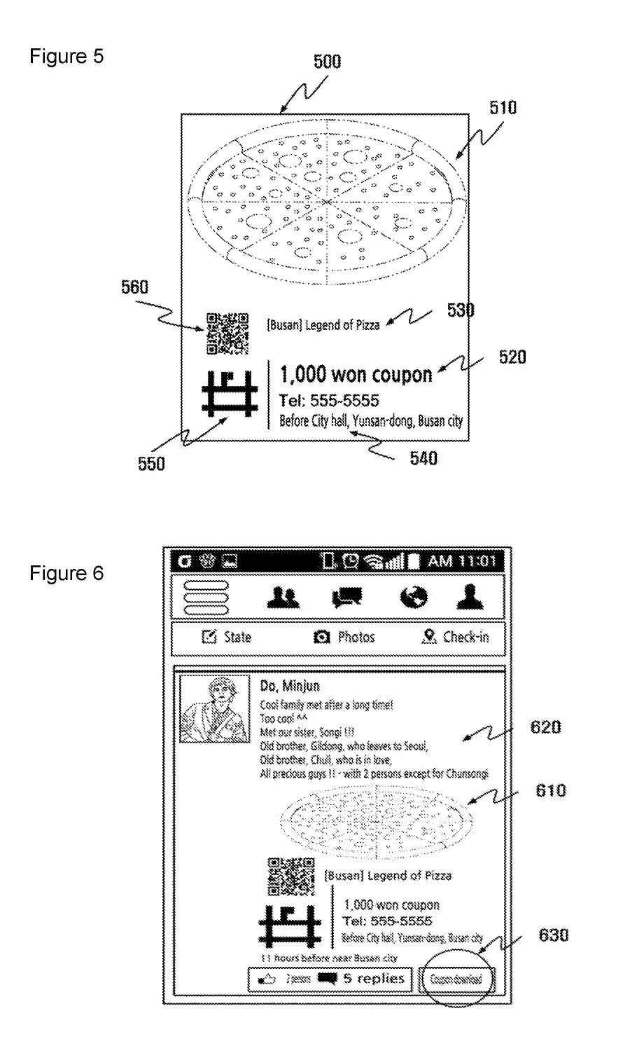

The coupon issuing method according to an exemplary embodiment in FIG. 3 may include steps which are time series processed by the coupon issuing system 100 in FIGS. 1 and 2. Therefore, if there are any contents which were omitted, the above contents on the coupon issuing system 100 in FIGS. 1 and 2 may apply to the coupon issuing method according to an exemplary embodiment in FIG. 3.

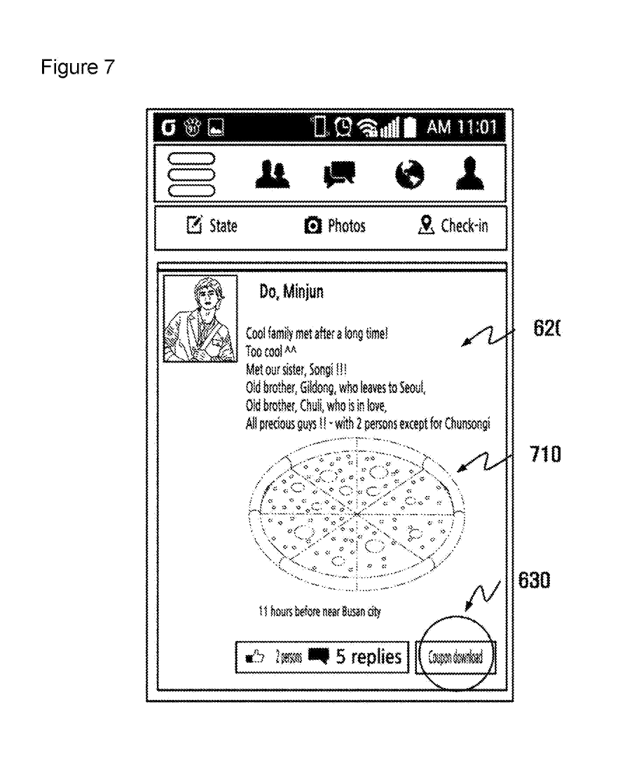

The configuration in FIG. 3 will be described later with reference to FIGS. 4 to 7, and FIGS. 4 to 7 are views illustrating a coupon issuing method according to an exemplary embodiment of the present invention.

The coupon issuing method may be may be executed in case where a program for executing the coupon issuing method is installed at a user terminal or may be triggered when the user requests the generation of coupons.

As illustrated in FIG. 3, the coupon issuing system 100 may obtain an image information and a shop identification information (S310).

For this, the coupon issuing system 100 may obtain an image information through the photographing interface. For example, if the camera is provided as a photographing interface, the coupon issuing system 100 may obtain an image information in such a way to photograph a photographing target using the camera.

In addition, the coupon issuing system 100 may obtain a shop identification information through an input interface. For example, in order to obtain a shop identification information provided in a form of a QR code, the coupon issuing system 100 may provide a QR reader as an input interface, thus obtaining a shop identification information by photographing the shop identification information using the reader.

The obtainable image information and shop identification information may be simultaneously obtained by the coupon issuing system 100.

The coupon issuing system 100 may first obtain an image information and then may provide an input interface to receive the shop identification information, whereupon the shop identification may be inputted through the input interface.

The coupon issuing system 100 may first obtain a shop identification information and then may provide a photographing interface to generate an image information based on the obtaining of the shop identification information, thus obtaining an image information.

FIG. 4 is a view for describing the coupon issuing method according to the present invention while showing a procedure wherein the image information is obtained.

On the user terminal 10, the first user may first obtain a shop identification information which may be attached on a table of the shop where sells foods in a form of the QR code. As the shop identification information is obtained, the coupon issuing system 100 may provide a photographing interface which allows the user to photograph foods by operating the camera of the user terminal 10. As illustrated in FIG. 4, when the food 410 is photographed through the photographing interface, the coupon issuing system 100 may obtain the thusly photographed image as an image information.

When the image information and shop identification information are obtained in the above way, the coupon issuing system 100 may generate a coupon on the basis of the image information and shop identification information (S320).

At this time, the coupon issuing system 100 may determine the matching of the image information and shop identification information on the basis of the position information of the image information. The coupon may be issued in case of matching. More specifically, the coupon issuing system 100 may generate a coupon only if in case where the position information of the image information is a shop “A”, the shop identification information of the shop “A” is received. If the shop identification information of a shop “B” is received, the generation of the coupon may be blocked.

FIG. 5 is a view for describing the coupon issuing method according to the present invention. It shows a coupon 500 issued based on the coupon issuing method according to the present invention.

As illustrated in FIG. 5, a coupon 500 may include a coupon information. The coupon information may include, but is not limited to, an image information 510, a benefit information 520, a shop name information in shop information, a shop position information and shop contact information 540 and 550, and a user identification information 560 of a first user.

For this, instead of the user identification information of the first user, a newly generated identification information may be added to the coupon information. For example, a newly generated identification information may be added to the coupon information in such a way to combine the user identification information of the first user and the user identification information (or shop identification information) of the third user matching with the shop.

The thusly generated coupon may be stored on the user account of the first user.

In addition, the coupon issuing system 100 may provide coupons (S330).

The coupon issuing system 100 may upload coupons in order for the second user who may have access to the coupon issuing system 100 to download the coupon.

In addition, the coupon issuing system 100 may allow the coupon to be transferred to a third party server in such a way to transmit a coupon information to the third party server to which the second user may have access while communicating with the coupon issuing system.

For example, the coupon issuing system 100 may upload the coupon on the coupon issuing system 100 so that the second user who has an acquaintance relationship with the first user can read the coupon on the coupon issuing system 100.

For example, the coupon issuing system 100 may transfer a coupon information to the account of the first user of the third party server which provides a SNS, and the third party server may upload the coupon on the user account of the first user of the third party server, thus providing the coupons. In addition, the second user who has an acquaintance relationship with the first user on the third party server may read the coupon posted on the user account of the first user of the third party server.

For example, the coupon issuing system 100 may transfer the coupon to the third party server which provides a chatting service. To this end, the third party server may share the coupons in a chatting room wherein the first user enters, thus providing the coupons. The second user who has an acquaintance relationship with the person who enters the chatting room can read the coupon.

FIGS. 6 and 7 are views for describing the coupon issuing method according to an exemplary embodiment of the present invention while showing a configuration of the coupon through the third party server.

Referring to FIG. 6, the first user may post the coupon 610 together when posting a text 620 on the third party server. The second user who can read the text 620 because he has an acquaintance relationship with the first user may obtain the coupon on the reading interface 630 which allows the obtaining of the coupon. At this time, the coupon 610 may be posted in whole or as illustrated in FIG. 7, part of the coupon may be posted, which allows to protect the natural purpose (for example, only the image information in the coupon information is allowed to share) of the third party server.

The coupon issuing system 100 may allow the selections of the coupon which will be provided to the second user based on the characteristic of the second user who may read the coupon. For example, if the category of the coupon that the second user read with the highest frequency is “pizzas”, only the coupon related with the pizza among the multiple coupons generated by the first user may be selected and provided to the second user. For example, if the location of the second user is “Pusan”, only the coupon which may be used only at Pusan among the multiple coupons may be selected and provided to the second user.

The second user may store the thusly posted coupon on the account of himself or may download through the user terminal controlled by himself.

The coupon issuing system 100 may confirm if the coupon was used by the second user (S340).

For example, if the shop corresponding to the coupon is an offline shop, when there is an input containing a notification that a coupon has been received from the terminal (for example, POS terminal) of the offline shop (for example, if a coupon identification information is received or there is an input wherein a third user confirms that the coupon has been received), the coupon issuing system 100 may confirm that the coupon has been used. For example, if the shop corresponding to the coupon is an online shop, when a coupon information is inputted as an item is purchased at the online shop, the use of the coupon can be confirmed.

When the use of the coupon is confirmed, points may be accumulated on the user account of the first user (S350). At this time, only if the confirmation time is over a predetermined range as compared to the generation time of the coupon, the points can be accumulated on the user account of the first user. In addition, any benefits may be accumulated on the user account of the first user only if the user identification information of the second user who wants to use the coupon is obtained. At this time, the user identification information of the second user may be formed with a series of characters or numbers or may be implemented with a one-dimensional barcode, a two-dimensional barcode, a three-dimensional barcode, etc. or may be implemented with a RFID tag or a NFC tag.

The above steps 340 to 350 may be repeatedly performed whenever the confirmation of the coupon is requested. Therefore, the first user who has generated the coupon may be continuously guaranteed with the accumulations of the benefits for the generation of the coupon.

The first user may freely use the accumulated benefits at the shop registered in the coupon issuing system 100. Whichever the benefits are accumulated, the first user can purchase using such benefit an item that he wants to at a shop wherein the use of the benefit is affiliated.

The second user who used the coupon generated by the first user may evaluate the first user.

The coupon issuing method according to the exemplary embodiment described in FIG. 3 may be implemented using a recording medium which includes commands executable by a computer like a program module executed by the computer. The computer readable medium may be a predetermined available medium to which the computer may access or may be a volatile medium, a non-volatile medium, a separable medium or a non-separable medium. In addition, the computer readable medium may include a computer storing medium and a communication medium. The computer storing medium may include a computer readable command, a data structure, a program module or a predetermined method for storing information like other data or a volatile medium, a non-volatile medium, a separable medium or a non-separable medium which may be implemented with technologies. The communication medium may include a typical computer readable command, a data structure, a program module, other data of modulated data signals like carrier waves, other transfer mechanisms, etc. and may include a predetermined information transfer medium.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

The scope of the present invention may be defined by the claims below. It should be understood that all modifications or modified configurations which may be derived from the meaning, scope and equivalent concepts of the claims should be included in the scope of the present invention.

1. A coupon issuing method which may be executed by a coupon issuing system wherein an interaction with a first user is available, comprising:
obtaining an image information and shop identification information generated by the first user;
generating a coupon on the basis of the image information and shop identification information; and
issuing the generated coupon.

2. The method of claim 1, wherein the step for obtaining the image information and shop identification information comprises:
obtaining a shop identification information;
providing a photographing interface for the generation of the image information on the basis of the obtaining of the shop identification information; and
generating an image information through the photographing interface.

3. The method of claim 1, wherein the step for obtaining the image information and shop identification information comprises:
obtaining an image information;
providing an input interface for the obtaining of the shop identification information; and
inputting the shop identification information through the input interface.

4. The method of claim 1, wherein the step for generating the coupon comprises:
obtaining a shop information which corresponds to the shop identification information and includes at least one of the shop identification information, a shop name information, a shop location information and a shop contact information; and
generating a coupon in such a way to add, to the coupon information, any least one of a user identification information of the first user who has provided the image and the shop information.

5. The method of claim 1, wherein the step for generating the coupon comprises:
determining the matching of the image information and the shop identification information on the basis of the position information of the image information; and
generating the coupon on the basis of a result of the determination.

6. The method of claim 1, wherein the step for providing the coupon comprises:
providing the coupon to a third party server in such a way that the coupon is transferred to the third party server configured for a second user different from the first user to have access to, while communicating with the coupon issuing system.

7. The method of claim 1, further comprising:
confirming the use of the coupon; and
accumulating a benefit corresponding to the coupon on a user account of the first user if the use of the coupon has been confirmed.

8. The method of claim 7, wherein the step for confirming the use of the coupon comprises:
confirming that the coupon has been used, if the user identification information of the second user who wants to use the coupon is obtained together with a confirmation request for the use of the coupon.

9. The method of claim 7, wherein the step for accumulating on the user account of the first user comprises:
accumulating on the user account of the first user only if the confirmation time of the coupon is over a predetermined range as compared with the generation time of the coupon.

10. A coupon issuing system wherein an interaction with a first user is available, comprising:
an information obtaining unit configured to obtain an image information and shop identification information generated by the first user;
a coupon generating unit configured to generate a coupon on the basis of the image information and shop identification information; and
a coupon issuing unit for issuing the generated coupon.

11. The system of claim 10, wherein the information obtaining unit is configured to obtain a shop identification information, provide a photographing interface for the generation of the image information on the basis of the obtaining of the shop identification information, and generate an image information through the photographing interface.

12. The system of claim 10, wherein the information obtaining unit is configured to obtain an image information, provide an input interface for the obtaining of the shop identification information, and input the shop identification information through the input interface.

13. The system of claim 10, wherein the coupon generating unit is configured to obtain a shop information which corresponds to the shop identification information and includes at least one of the shop identification information, a shop name information, a shop location information and a shop contact information, and generate a coupon in such a way to add, to the coupon information, any least one of a user identification information of the first user who has provided the image and the shop information.

14. The system of claim 10, wherein the coupon generating unit is configured to determine the matching of the image information and the shop identification information on the basis of the position information of the image information, and generate the coupon on the basis of a result of the determination.

15. The system of claim 10, wherein the coupon issuing system is able to communicate with a third party server to which a second user different from the first user has access, and the coupon issuing system is able to provide the coupon through the third party server in such a way to transfer the coupon to the third party server.

16. The system of claim 10, further comprising an account managing unit which is configured to confirm the use of the coupon, and accumulate a benefit corresponding to the coupon on a user account of the first user if the use of the coupon has been confirmed.

17. The system of claim 16, wherein the account managing unit is configured to confirm that the coupon has been used, if the user identification information of the second user who wants to use the coupon is obtained together with a confirmation request for the use of the coupon.

18. The system of claim 16, wherein the account managing unit is configured to accumulate on the user account of the first user only if the confirmation time of the coupon is over a predetermined range as compared with the generation time of the coupon.
